(19) United States
(12) Patent Application Publication
(10) Pub. No.: US 2025/0191400 A1
(43) Pub. Date: Jun. 12, 2025

(54) EXTRACTION OF DIMENSION DATA USING IMAGE PROCESSING AND DEEP LEARNING ALGORITHM

(71) Applicant: L&T TECHNOLOGY SERVICES LIMITED, Chennai (IN)

(72) Inventors: TARUN KUMAR DAS, Digboi (IN); TRIPTESH MALLICK, Bankura (IN); MRIDUL BALARAMAN, Bangalore (IN); MADHUSUDAN SINGH, Bangalore (IN)

(21) Appl. No.: 18/531,749

(22) Filed: Dec. 7, 2023

(51) Int. Cl. G06V 30/422; G06V 30/19; G06V 30/413

(52) U.S. Cl. CPC G06V 30/422; G06V 30/19107; G06V 30/413

(57) ABSTRACT

A method of extracting dimension data from a document is disclosed. The method includes receiving the document comprising at least one two-dimensional figure and a plurality of dimension sets associated with the at least one two-dimensional figure. The method may include detecting the at least one two-dimensional figure in the document. The method may further include detecting the plurality of dimension sets distinctly from the at least one two-dimensional figure in the document. Further, the method may identify a plurality of arrowheads associated with the plurality of dimension sets. The method may include clustering the plurality of arrowheads to obtain a plurality of set of arrowheads. The method may further include mapping each of the plurality of set of arrowheads with the dimension value and extracting dimension data corresponding to each of the plurality of set of arrowheads based on the mapping.

### TECHNICAL FIELD

This disclosure relates generally to extraction of dimension data from a document and more particularly to using image processing and deep learning algorithms to extract the dimension from engineering drawings related documents.

### BACKGROUND OF THE INVENTION

Typically, a two-dimensional engineering drawing document contains a lot of information related to such as drawing entities and non-drawing entities and thus segregating each aspect/component from the document is a time consuming, tedious task and is a very important task as per human capability. Further, a dimension set in the document represents a collection of information that is present in the engineering drawing document. The dimension set aids in recreation of drawings of the document and provides insights on various measurements of the geometrical shapes such as length and radius related to the drawings present in the document. The present invention relates to using an AI algorithm, for extracting non-drawing entities from drawing entities. Using the data from the dimension sets, an AI system may be created to automate the drawing tracing process.

There is therefore a need in the art to provide a trained machine learning model to automate tracing of dimension data to extract dimension set from the drawing document.

### SUMMARY OF THE INVENTION

In an embodiment, a method of extracting dimension data from a document is disclosed. The method may include receiving the document comprising at least one two-dimensional figure and a plurality of dimension sets associated with the at least one two-dimensional figure. It should be noted that, each of the plurality of dimension sets may comprise a dimension value, a set of extension lines associated with the dimension value, and a set of arrowheads associated with the dimension value. The method may include detecting the at least one two-dimensional figure in the document. The method may further include detecting the plurality of dimension sets distinctly from the at least one two-dimensional figure in the document. The method may further include identifying a plurality of arrowheads associated with the plurality of dimension sets, upon detecting the plurality of dimension sets. The method may include clustering the plurality of arrowheads to obtain a plurality of set of arrowheads. The method may further include mapping each of the plurality of set of arrowheads with the dimension value. The method may include extracting dimension data corresponding to each of the plurality of set of arrowheads, based on the mapping.

In another embodiment, a system for extracting dimension data from a document is disclosed. The system includes a processor and a memory communicatively coupled to the processor. The memory may store processor-executable instructions, which, on execution, may causes the processor to receive the document comprising at least one two-dimensional figure and a plurality of dimension sets associated with the at least one two-dimensional figure. It should be noted that, each of the plurality of dimension sets may include a dimension value, a set of extension lines associated with the dimension value, and a set of arrowheads associated with the dimension value. The processor-executable instructions, on execution, may causes the processor to detect the at least one two-dimensional figure in the document. The processor-executable instructions, on execution, may causes the processor to detect the plurality of dimension sets distinctly from the at least one two-dimensional figure in the document. The processor-executable instructions, on execution, may causes the processor to identify a plurality of arrowheads associated with plurality of dimension sets, upon detecting the plurality of dimension sets. The processor-executable instructions, on execution, may causes the processor to cluster the plurality of arrowheads to obtain a plurality of set of arrowheads. The processor-executable instructions, on execution, may causes the processor to map each of the plurality of set of arrowheads with the dimension value. The processor-executable instructions, on execution, may causes the processor to extract dimension data corresponding to each of the plurality of set of arrowheads, based on the mapping.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a diagram illustrating different components of a dimension set, in accordance with an exemplary embodiment of the present disclosure.

FIG. 2 is a diagram illustrating different components of a two-dimensional engineering drawing document, in accordance with an embodiment of the present disclosure.

FIG. 3 is a process flow diagram illustrating a mechanism for extracting dimension data from a document, in accordance with an embodiment of the present disclosure.

FIG. 4 is a pictorial representation of a training image dataset, in accordance with an embodiment of the present disclosure.

FIG. 5 is an exemplary diagram depicting a set of extension lines detected using an image processing algorithm, in accordance with an embodiment of the present disclosure.

FIG. 6 is an exemplary diagram illustrating a plurality of arrowheads clustered based on a plurality of orientation-based classification, in accordance with an embodiment of the present disclosure.

FIG. 7 is an exemplary diagram illustrating a set of dimension text detected using an image processing algorithm, in accordance with an embodiment of the present disclosure.

FIG. 8 is a process flow diagram for clustering a plurality of arrowheads to obtain a plurality of set of arrowheads, in accordance with an embodiment of the present disclosure.

FIG. 9 is an exemplary diagram illustrating at least one two-dimensional figure converted into a binary image, in accordance with an embodiment of the present disclosure.

FIG. 10-12 illustrates exemplary drawings representing detection of a plurality of arrowheads and clustering of the plurality of set of arrowheads, in accordance with an embodiment of the present disclosure.

FIG. 11 is an exemplary diagram illustrating clustering of a plurality of arrowhead to obtain a plurality of sets of arrowheads, in accordance with an embodiment of the present disclosure.

FIG. 12 is an exemplary diagram illustrating merging a set of extension line to one of the plurality of dimension sets, in accordance with an embodiment of the present disclosure.

FIG. 13 illustrates a flowchart of a method for extracting dimension data from the document, in accordance with an embodiment of the present disclosure.

FIG. 14 is a flow diagram of a method for extraction of dimension data from the document, in accordance with an embodiment of the present disclosure

FIG. 15 is an exemplary diagram illustrating a pair of arrows in a horizontal, a vertical, and an oblique direction, in accordance with an embodiment of the present disclosure.

FIG. 16. represents an exemplary diagram illustrating classification of a plurality of arrowheads in eight directions, in accordance with an embodiment of the present disclosure.

FIG. 17. an exemplary computing system employed to implement processing functionality for various embodiments is illustrated, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

A dimension set is an important aspect of a two-dimensional engineering drawing. The dimension set within a dimension data may highlight a dimension (for example, distance) of any of a geometrical entity-radially (for example, as circle or curves) and longitudinally (for example, as lines). Though the dimension set may not be a part of the drawing but may contain all of the information of the drawing. Extraction of the dimension set as part of a pre-processing process is essential so as to consider determining remaining part of the drawing (for example, lines, circles, splines).

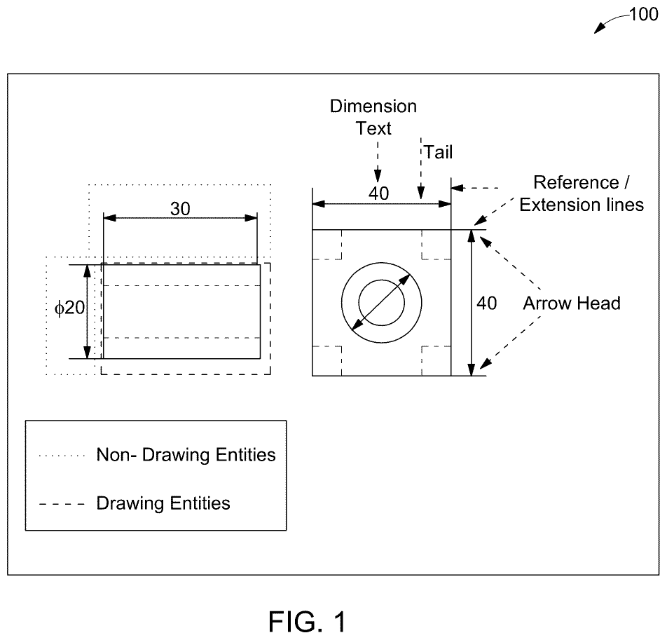

Referring to FIG. 1, a diagram 100 illustrating different components of a dimension set is represented, in accordance with an exemplary embodiment of the present disclosure. In an embodiment, the dimension set may be associated with at least one two-dimensional figure detected from a document. As will be appreciated, the document may correspond an engineering drawing document. Further, as depicted via the present FIG. 1, the dimension set may include a dimension value, a set of extension lines associated with the dimension value, and a set of arrowheads associated with the dimension value. Each of the dimension set may be separately extracted using an image processing algorithm and a machine learning model. Further, each of the separately extracted dimension set may then be combined to form a complete dimension set (also referred as a dimension data or a list of dimension set). In an embodiment, the machine learning model may use a deep learning algorithm to extract the dimension set. In present FIG. 1, the dimension value is represented via a dimension text, i.e., ‘40’. The set of extension lines are represented via ‘reference/extension lines’. One of the set of arrowheads is represented via ‘arrow head’.

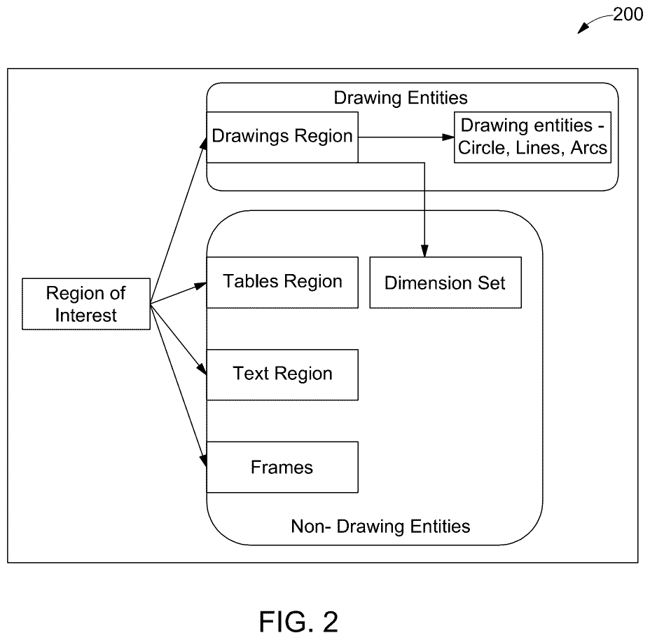

Referring to FIG. 2, a diagram 200 illustrating different components of a two-dimensional engineering drawing is represented, in accordance with an embodiment of the present disclosure. The different components of each of the two-dimensional engineering drawings may include a set of entities. As depicted via the present FIG. 2, the set of entities may correspond to a region of interest. The set of entities may include drawing entities and non-drawing entities. The drawing entities may include drawing region and drawing information text. Examples of drawing entities may include, but is not limited to, circles, lines, and arcs. Further, the non-drawing entities may include, but is not limited to, tables region (e.g., table area), text region (e.g., free text region, text inside title box, text outside frame, etc.), frames, and dimension sets. These entities may be referred as the dimension set. The dimension set may provide exact definition of an object dimensions.

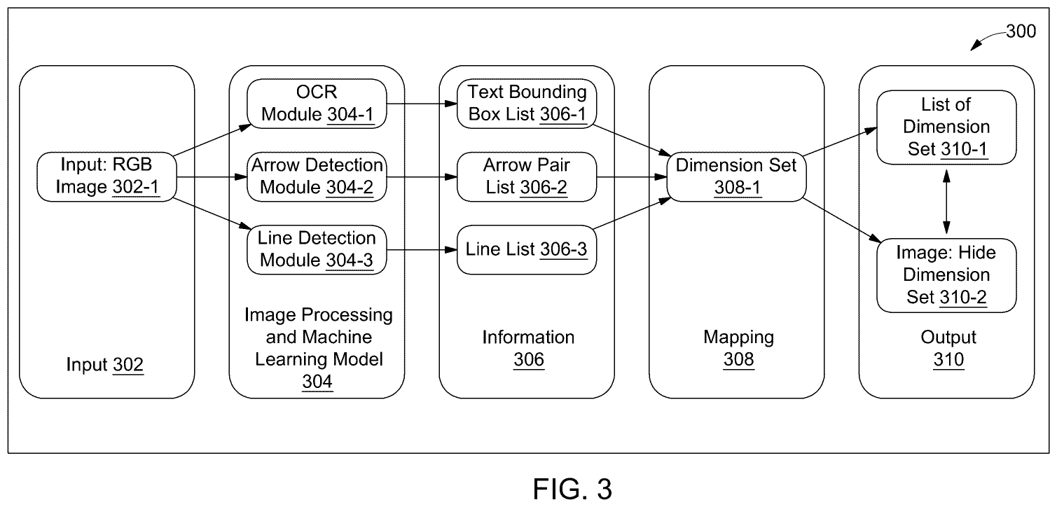

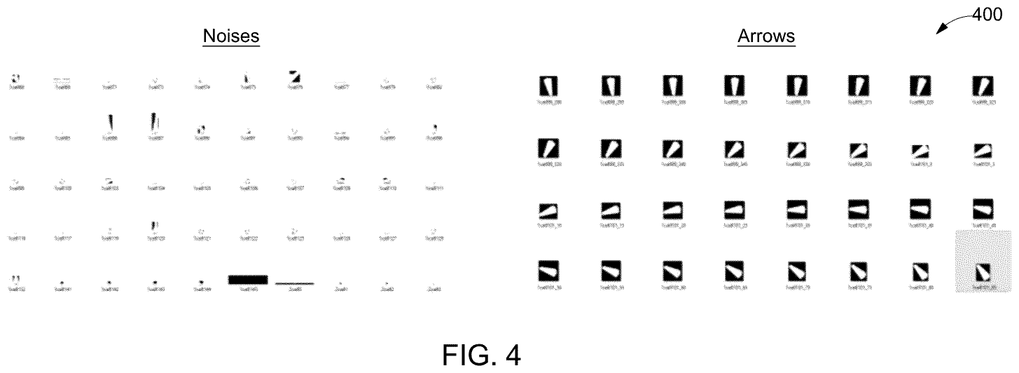

Referring to FIG. 3, a process flow diagram 300 illustrating a mechanism for extracting dimension data from a document is represented, in accordance with an embodiment of the present disclosure. In an embodiment, the document may correspond to an engineering drawing document. Initially, at step 302, an input may be received. The input may include a multi color image 302-1. The multi-color image 302-1 may have a red, a blue, and a green component. The multi-color image 302-1 may also be referred as an RGB (red, blue, green) image. In an embodiment, the multi-color image 302-1 may correspond to the at least one two-dimensional figure. Upon receiving the multi-color image 302-1 may be converted to a binary image. Upon converting the multi-color image 302-1 to the binary image, at step 304, a plurality of dimension sets may be detected using an image processing algorithm and a machine learning model. In an embodiment, each of the plurality of dimension sets may include the dimension value, the set of extension lines associated with the dimension value, and the set of arrowheads associated with the dimension value. It should be noted that, the machine learning model may be trained using a training image dataset. The training image dataset may include a training dataset of a set of images of unique true arrowheads and a training dataset of a set of images of false arrowhead (also referred as noises) as represented via FIG. 4. In the FIG. 4, the training dataset of the set of images of false arrowheads is represented as ‘noises’ and the training dataset of the set of images of unique true arrowheads is represented as ‘arrows’. Further, the training of the machine learning model may be done based on a pre-assumed threshold value.

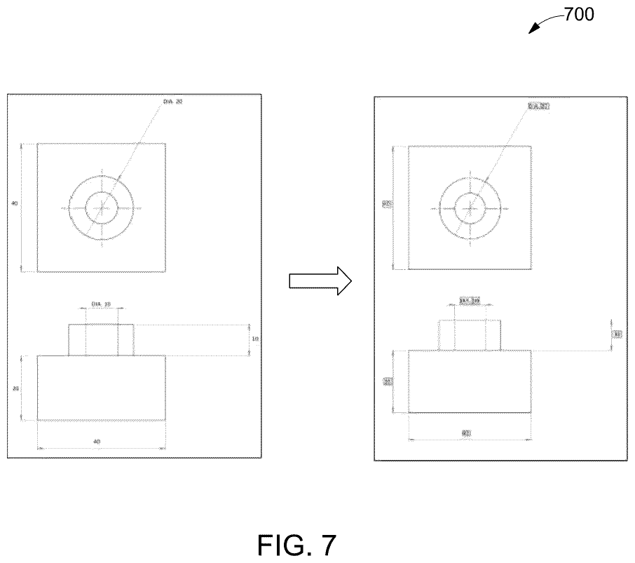

In order to extract dimension data from the binary image, the machine learning model include an optical character recognition (OCR) module 304-1, an arrow detection module 304-2, and a line detection module 304-3. Initially, the OCR module 304-1 may be used to determine a textual portion present in the binary image. In order to determine the textual portion, the OCR module 304-1 may perform text localization. The text localization is performed to identify localized coordinates of the textual portion to extracts a dimension text (i.e., the dimension value) from the binary image. An example of a set of dimension text detected using an image processing algorithm is illustrated via the exemplary diagram 700 of FIG. 7. Further, the arrow detection module 304-2 may be configured to identify a plurality of arrows and via a sparse pixel vectorization, a segmentation of text-like and symbol-like objects, and global or local thresholding. Moreover, the arrow detection module 304-2 may be configured to identify a plurality of arrowheads associated with each of the plurality of arrows.

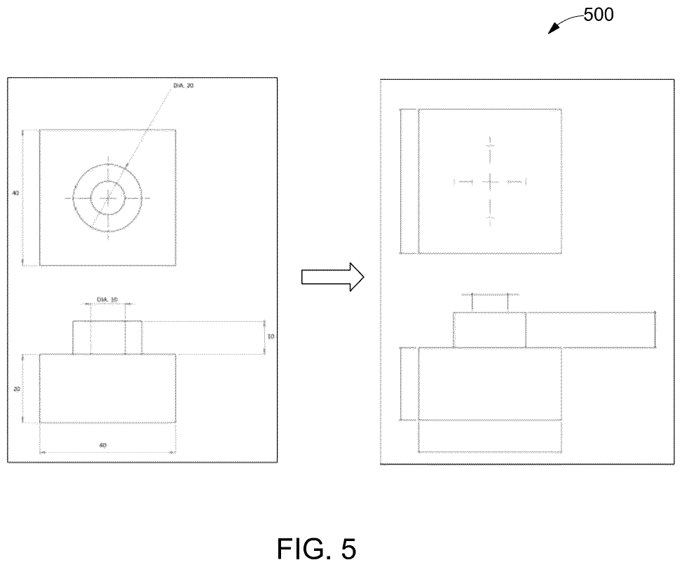

In addition, the line detection module 304-3 may be configured to detect the set of extension lines, such as, horizontal lines, vertical lines, and inclined lines (if any) in the binary image using the image processing algorithm (for example: dilation and erosion process, as shown in FIG. 5). Further, the plurality of arrowheads identified may be annotated with annotation data. The annotation data may include an orientation of each of the plurality of arrowheads and a location of each of the plurality of arrowheads. In an embodiment, the plurality of arrowheads identified may be classified into one of a plurality of orientation-based classifications based on the annotation data and a pre-defined rule. The plurality of orientation-based classifications, may include an upward orientation, a downward orientation, a left orientation, a right orientation, a left-upward orientation, a left downward orientation, a right-upward orientation, and a right-downward orientation.

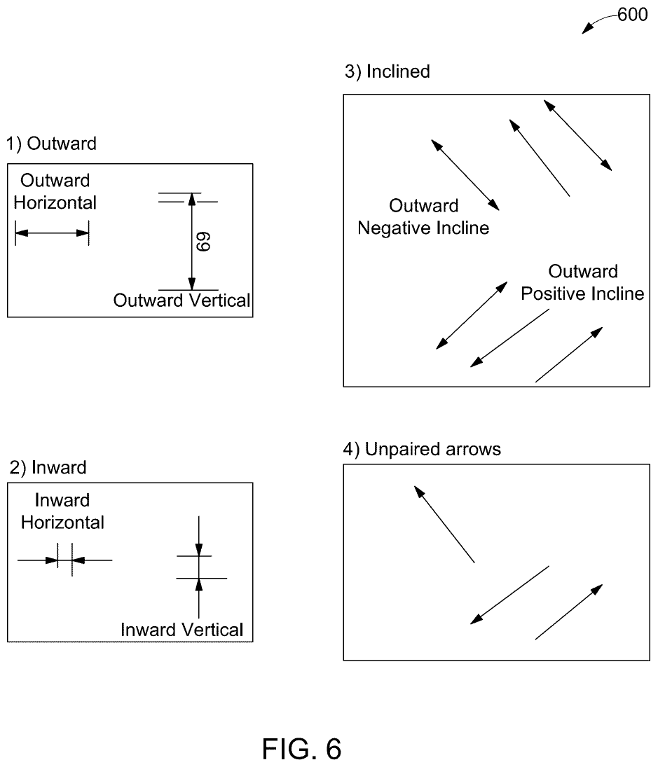

Thereafter, the plurality of arrowheads may be clustered to obtain a plurality of set of arrowheads. The clustering of the plurality of set of arrowheads may be done based on the plurality of orientation-based classification. By way of an example, the clustering of the plurality of arrowheads may be done based on a combination of one or more of the plurality of orientation-based classification. An example of clustering of the plurality of arrowheads based on the plurality of orientation-based classification is shown via an exemplary drawing 600 as represented via FIG. 6.

Further, the line detection module 304-3 may identify coordinate points and thickness of each of the set of extension lines detected in the binary image. FIG. 5 represents an exemplary diagram depicting a set of extension lines detected using the image processing algorithm. The textual portion determined by the OCR module 304-1, the plurality of arrows and the plurality of arrowheads determined by the arrow detection module 304-2, the set of extension lines detected by the lines detection module 304-3 may be stored as a text bounding box list 306-1, an arrow pair list 306-2, and a line list 306-3 respectively as represented via step 306. As mentioned earlier, the machine learning model may be trained using the training image dataset (as shown in FIG. 4).

Further, at step 308, a mapping of each of the plurality of set of arrowheads with the dimension value may be carried out to form a dimension set 308-1. In order to perform mapping of each of the plurality of set of arrowheads with the dimension value, initially, position data associated with the binary image and each of the plurality of dimension set may be captured. Further, each of the plurality of set of arrowheads with the dimension value may be mapped based on the position data associated with the at least one two-dimensional figure and each of the plurality of dimension sets.

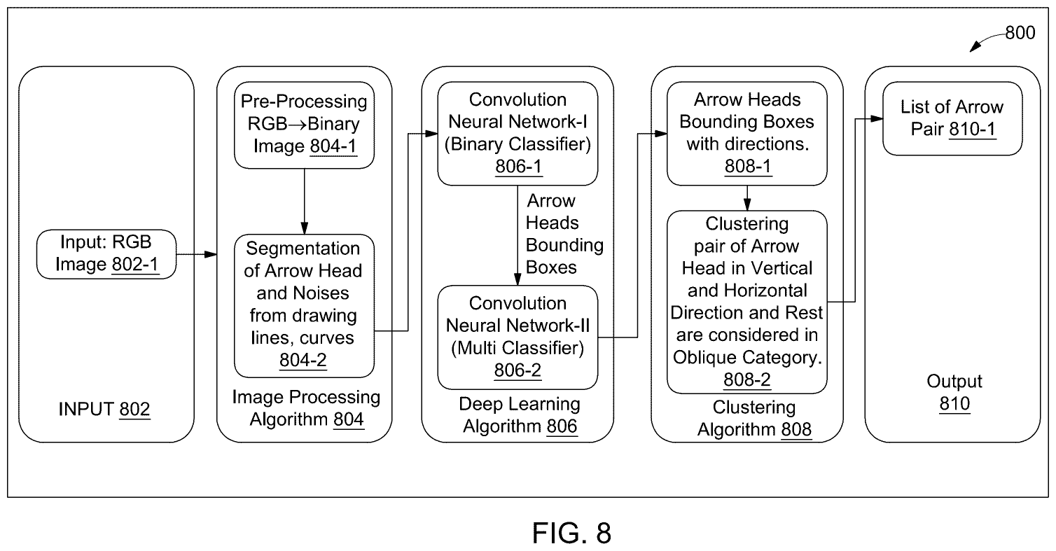

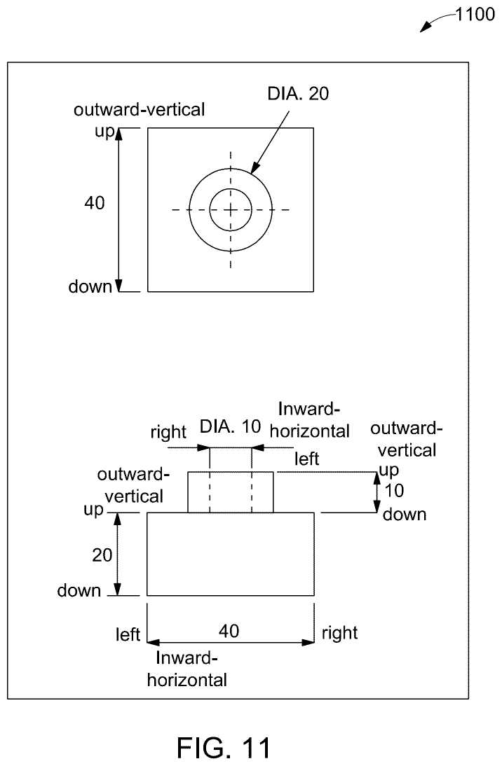

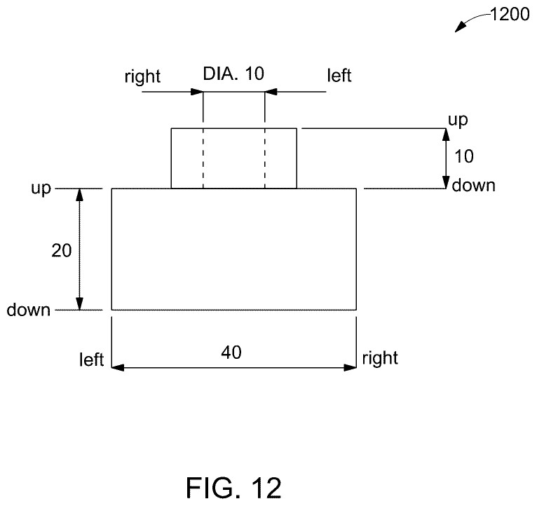

Once the mapping is done, at step 310, an extraction of dimension data may be performed based on mapping of each of the plurality of set of arrowheads with the dimension value. Further, the extraction may be done based on the annotation associated with each of the plurality of set of arrowheads and the coordinates of the set of extension lines. In an embodiment, the set of extension lines may be merged to a corresponding set of arrowheads based on a predefined rule. By way of an example, the pre-defined rule may include thickness of the set of extension lines and each of the set of extension lines should be perpendicular to the corresponding set of arrowheads. By way of another example, the predefined rule may be based on thickness and the set of extension lines should be perpendicular to the corresponding set of arrowheads which is always attached to a tip of an arrowhead. This is further explained in detail in reference to FIG. 8 to FIG. 14. Further, at step 310, and an output may be generated. In an embodiment, the list of dimension set 310-1 may include the annotations, the thickness, and the coordinates of each of the set of extension lines (also referred as reference lines). Further, the dimension text (same as the dimension value) may be associated with an arrowhead from the corresponding set of arrowheads and the set of extension lines. In some cases, guidelines may used to detect the region of interest and map the region of interest to the corresponding set of arrowheads, when the dimension text is outside a vicinity.

For example, first coordinates [x1, y, x2, y2] associated with the dimension set may be provided based on the annotation of the plurality of set of arrowheads and the coordinate points. Further, the dimension text corresponding to the dimension set may be merged. Thereafter, using the guidelines as a reference, the dimension text associated with the corresponding dimension set may be identified. Upon identifying the corresponding dimension set, a data frame may be represented. The data frame may be a final representation of the dimension set which contains information in a following structure [i.e., the coordinate of dimension set with the annotations, the coordinates of the set of extension lines, the dimension text (coordinate and ‘value’)]. This generated data frame may provide information in a structured format.

Referring now to FIG. 8, a process flow diagram 800 for clustering a plurality of arrowheads to obtain a plurality of set of arrowheads is disclosed, in accordance with an embodiment of the present disclosure. At step 802, a multi-color image 802-1 may be inputted to the machine learning model. In reference to FIG. 3, the multi-color image 802-1 may correspond to the at least one two-dimensional figure. In an embodiment, the machine learning model may utilize the image processing algorithm and the deep learning algorithm for performing further processing. The multi-color image 802-1 may correspond to an image with a Red, Green, Blue, (RGB) may be inputted. Once the RGB image is inputted, the RGB image may be preprocessed as depicted via step 804-1. The preprocessing of the RGB image may be performed using an image processing algorithm 804. In an embodiment, the pre-processing of the RGB image may be done to convert the RGB image into a binary image.

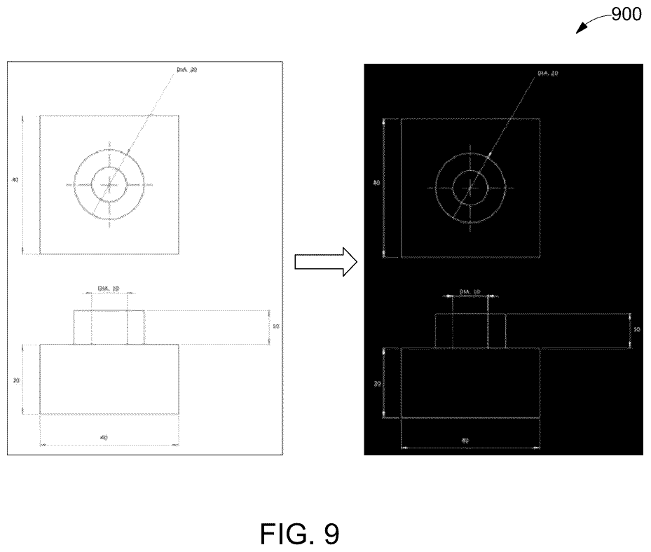

It should be noted that, the binary image may include a black background and a white foreground. In order to convert the RGB image into the binary image, following steps may be executed: Initially, the RGB image (also referred as a colored image) may be retrieved from a location. Upon retrieving, the RGB image may be converted to a grey scale image. Once converted to the grey scale image, a threshold value of each pixel position of the grey scale image may be determined. Further, one or more of each pixel position of the grey scale image with the threshold value 1 may be classified as the white-foreground based on a predefined threshold value. Further, one or more of each pixel location may be classified as 0 (black-background) based on the pre-defined threshold value. An exemplary diagram 900 illustrating at least one two-dimensional figure (i.e., the RGB image) converted into the binary image is depicted via FIG. 9.

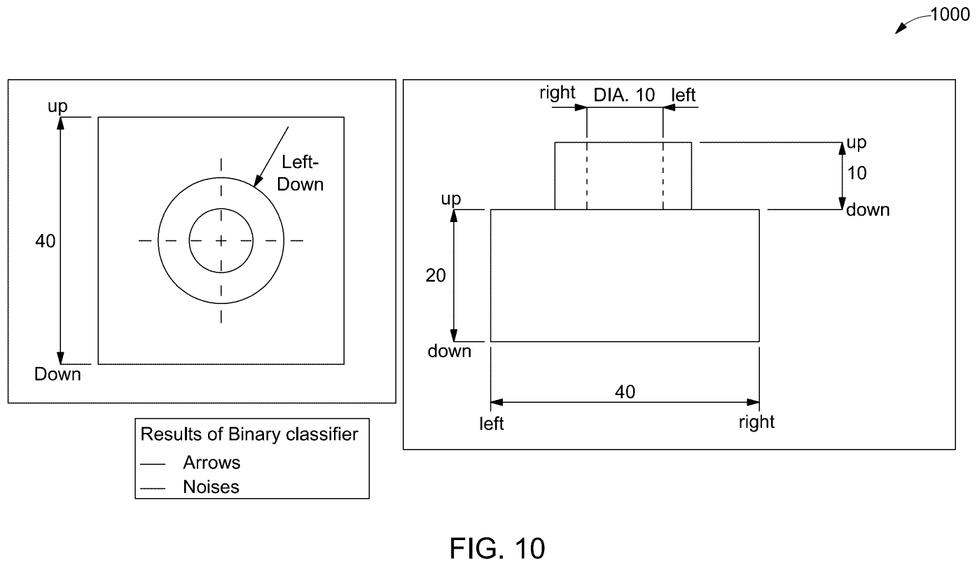

Once the RGB image is converted into the binary image, at step 804-2, segmentation of the plurality of arrowheads from the binary image may be performed. Once The segmentation of each of the plurality of arrowheads may be done to identify each of the plurality of arrowheads from the binary image. An exemplary representation of segmentation of the plurality of arrowheads is depicted via FIG. 10-12. FIGS. 10-12 represents exemplary drawings including detection of each of the plurality of arrowheads obtained after segmentation, identification of one or more of the plurality of arrowheads to form clusters in order to obtain the plurality of set of arrowheads. In an embodiment, the clustering of one or more of the plurality of arrowheads may be done to form pairs of arrowheads. The pair of arrowheads may be formed in vertical, horizontal, inclined, and merging extension line to form the dimension set.

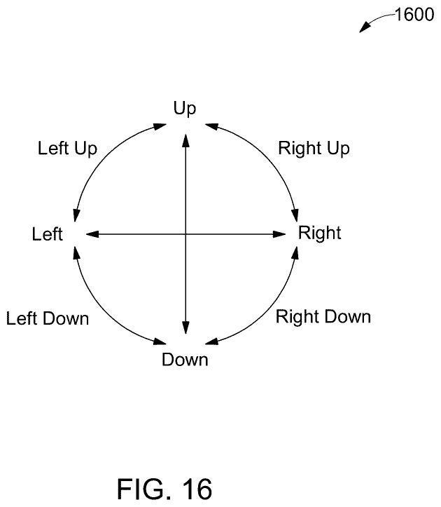

Upon segmenting each of the plurality of arrowheads, at step 806, the plurality of arrowheads may be processed via a deep learning algorithm (i.e., the trained machine learning model). In order to process the plurality of arrowheads, each of the plurality of arrowheads may be fed to a convolution neural network-I (CNN-I) at step 806-1. The CNN-I is a part of the deep learning algorithm and may utilize binary classifier. The deep learning algorithm may distinguish one or more of the plurality of arrowheads from noises based on the predefined threshold value. Thereafter, a CNN-II (for example, multi-class classifier) may further process each of the plurality of arrowheads with the plurality of dimension sets. Subsequently, at step 806-2, each of the plurality of arrowheads may be further classified based on into one of a plurality of orientation-based classifications based on the annotation data and a predefined rule. The plurality of orientation-based classifications, may include an upward orientation, a downward orientation, a left orientation, a right orientation, a left-upward orientation, a left downward orientation, a right-upward orientation, and a right-downward orientation. In other words, the plurality of orientation-based classifications may majorly include eight directions in which each of the plurality of arrowheads may be classified using the CNN-II, as shown in FIG. 16.

In an embodiment, upon identifying each of the plurality of arrowheads, each of the plurality of arrowheads may be annotated with annotation data. The annotation data may include an orientation of each of the plurality of arrowheads and a location of each of the plurality of arrowheads. At step 808-2, a clustering algorithm may cluster the plurality of arrowheads to obtain the plurality of set of arrowheads. In order to cluster the plurality of arrowheads in the plurality of set of arrowheads, each of the plurality of arrowheads may be classified in one of the plurality of orientation-based classifications. In other words, one or more of the plurality of arrowheads may be clustered to obtain a pair of arrowheads. For example, two of the plurality of arrowheads that are in the vertical and the horizontal direction may be clustered to form the pair of arrowheads. Once clustering of the plurality of arrowheads is performed, at step 810, an output may be generated. The output may correspond to the list of arrow pairs generated after clustering. In an embodiment, the list of arrowheads may correspond to the plurality of sets of arrowheads.

As will be appreciated, the CNN-II may correspond to a multilayered neural network with a special architecture to efficiently process, correlate and understand large amount of data in high-resolution images. In an embodiment, the CNN-I (i.e., the binary classifier) classifies elements into two groups, either true arrowheads (i.e., the set of images of true unique arrowheads) or false arrowheads (i.e., the set of images of false arrowheads). The false arrowheads are often referred to as noises. In order to perform binary classification, each prediction made by the multilayered neural network for the true arrowheads may be assigned to a positive class (1) when an estimated probability (p) exceeds a threshold value (the predefined threshold value). Whereas each prediction of the multilayered neural network of the false arrowhead may be assigned to a negative class (0) when the estimated probability is less than the threshold value. The positive class may be referred to as true arrowheads and the negative class may be referred to as false arrowheads. In an embodiment, in order to classify each of the plurality of arrowheads, a multiclass classification may be performed by the machine learning model. The multiclass classification may be done based on the deep learning algorithm that may consist of more than two classes or outputs and may create a dataset of eight classes (i.e., the plurality of orientation-based classification) to define various directions. The machine learning model may be presented with a training image dataset divided into eight separate classes. Further, the machine learning model may be trained using the deep learning algorithm to predict to a class from the eight classes (directions) of each of the arrowheads present in the training image dataset. A max value from the eight classes denotes the class of each of the arrowheads. In seeing the training image dataset, the machine learning model may learn patterns specific to each of the class and may use those patterns to predict the mapping of future data.

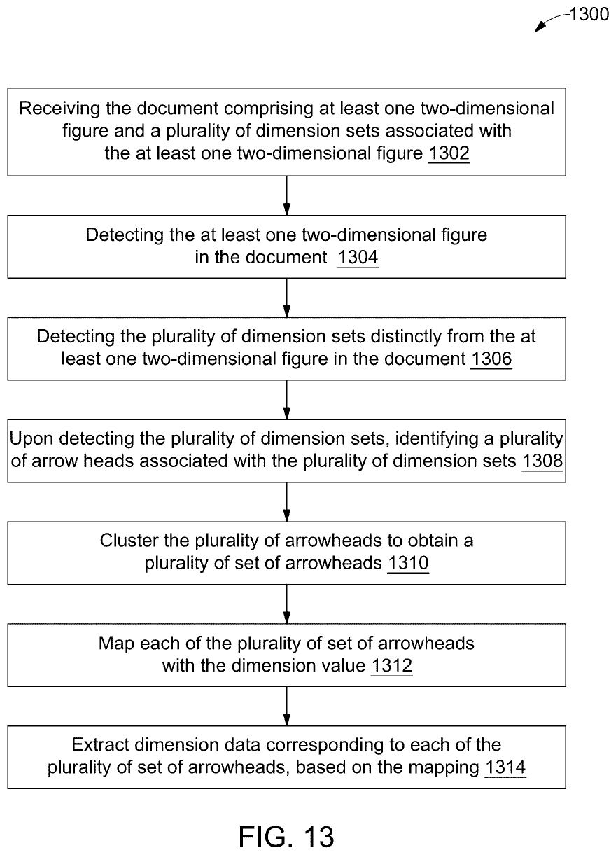

Referring now to FIG. 13, a method for extracting dimension data from the document is illustrated via a flowchart 1300, in accordance with an embodiment of the present disclosure. At step 1302, a document may be received as an input. The received document may include at least one two-dimensional figure and a plurality of dimension sets associated with the at least one two-dimensional figure. Further, each of the plurality of dimension sets may include a dimension value, a set of extension lines associated with the dimension value, a set of arrowheads associated with the dimension value. After receiving the document, at step 1304, the at least one two-dimensional figure may be detected in the document. Upon detecting the at least one two-dimensional figure, the at least one two dimensional figure may be converted into the binary image. It should be noted that, the conversion of the at least one two-dimensional figure into the binary image may be done as the at least one two-dimensional figure may be an RBG image.

Once the at least two-dimensional figure is detected and converted into the binary image, at step 1306, each of the plurality of dimension sets may be detected distinctly from the at least one two-dimensional figure in the document. Upon detecting each of the plurality of dimension sets, at step 1308, a plurality of arrowheads associated with the plurality of dimension sets may be identified. In an embodiment, the plurality of arrowheads may be identified via a trained machine learning model. The trained machine learning model may identify the plurality of arrowheads using a deep learning algorithm. In order to identify each of the plurality of arrowheads, initially, the machine learning model may be trained using a training image dataset. The training image dataset may include a set of images of unique true arrowheads and a set of images of false arrowheads (also referred as noises). Upon identifying each of the plurality of arrowheads, the each of the plurality of arrowheads may be annotated with annotation data. In an embodiment, the annotation data may include an orientation of each of the plurality of arrowheads and a location of each of the plurality of arrowheads.

Further, at step 1310, the plurality of arrowheads may be clustered to obtain a plurality of set of arrowheads. In an embodiment, the clustering of each of the plurality of arrowheads may be done to classify each of the plurality of arrowheads into one of a plurality of orientation-based classifications. The classification of each of the plurality of arrowheads in done based on the annotation data and a pre-defined rule. In an embodiment, the plurality of orientation-based classifications may include, but is not limited to, an upwards orientation, a downward orientation, a left orientation, a right orientation, a left-upwards orientation, a left-downward orientation, a right-upwards orientation, and a right-downward orientation. Furthermore, at step 1312, each of the plurality of set of arrowheads may be mapped with the dimension value. In an embodiment, the dimension value may correspond to the dimension text. In order to map each of the plurality of set of arrowheads, a position data associated with the at least one two-dimensional figure and each of the plurality of dimension sets may be captured. Upon capturing the position data, each of the plurality of set of arrowheads may be mapped with the dimension value based on the position data associated with the at least one two-dimensional figure and each of the plurality of dimension sets. Further, at step 1314, a dimension data corresponding to each of the plurality of set of arrowheads may be extracted based on the mapping of each of the plurality of set of arrowheads with the dimension value.

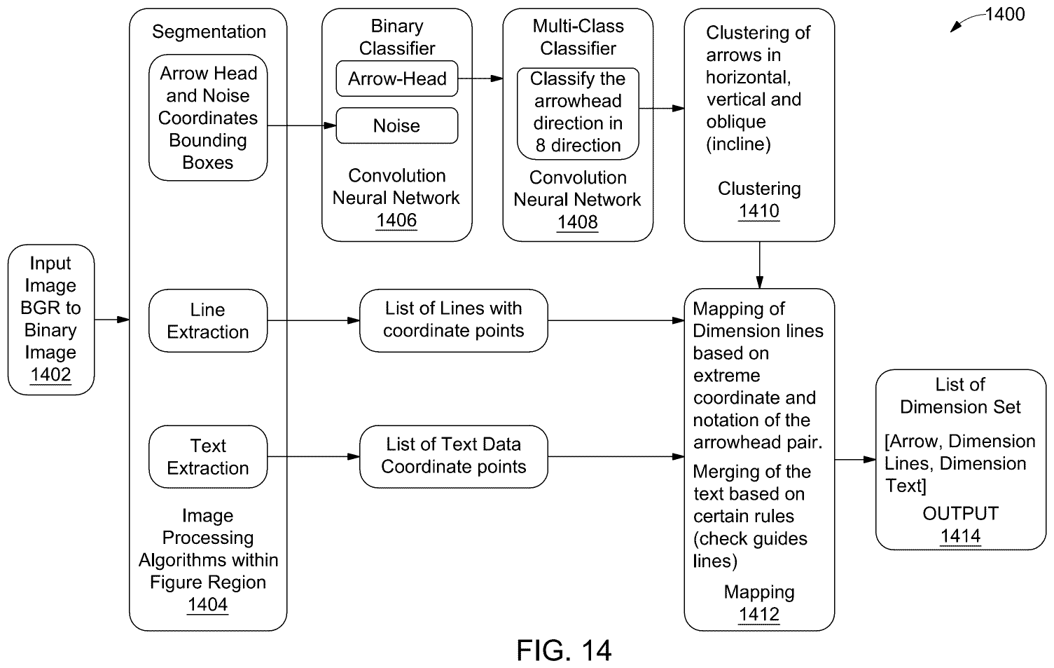

Referring now to FIG. 14, a flow diagram 1400 for extraction dimension data from the document illustrated, in accordance with an embodiment of the present disclosure. At step 1402, an input image (i.e., the RGB image) may be converted to the binary image. In reference to FIG. 13, the input image may correspond the at least one-two dimensional figure. Once the input image is converted into the binary image, at step 1404, the binary image may be segmented using the image processing algorithm. In an embodiment, the segmentation of the binary image may include three steps. Initially at first step, each of the plurality of arrowheads and noise bounding boxes may be segmented from the binary image which is further done in two steps, first step includes classification of arrowhead and noise using CNN-I 1406 (i.e., the binary classifier). Further second step includes classification of each of the plurality of arrowhead in eight directions using CNN-II 1408 (i.e., the multi-class classifier). Once the plurality of arrowheads and the noise bounding boxes are segmented, then at second step, each of the set of extension lines corresponds to a list of extension lines with coordinate points (position data) may be extracted. Further, at third step, text corresponding to a list of text data with coordinate points may be extracted.

At step 1410, clustering of each of the plurality of arrowheads may be performed to obtain the plurality of set of arrowheads. Further, at step 1412, mapping of each of the plurality of set of arrowheads with the dimension value may be performed. Once the mapping is performed, at step 1414, an output as a list of dimension set may be extracted. The output may include dimension data associated with each of the plurality of set of arrowheads. The dimension data may include a list of dimension set comprise a set of arrows, a set of extension lines, and a set of dimension text.

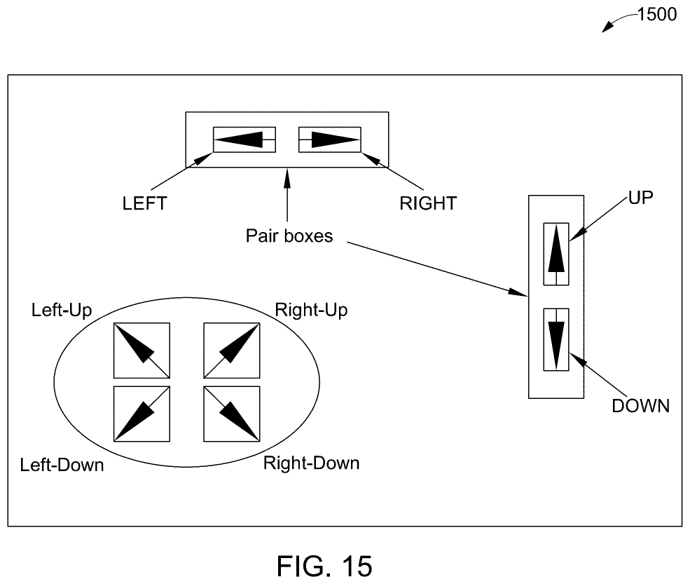

Referring now to FIG. 15, an exemplary diagram 1500 illustrating a pair of arrows in a horizontal, a vertical, and an oblique direction is presented, in accordance with an embodiment of the present disclosure. In an embodiment, once the direction (i.e., the orientation) of each of the plurality of arrowheads is classified, the coordinate and the annotation associated with each of the plurality of arrowheads may be saved as—[x1, y1, x2, y2, ‘Notation’] in three list groups. The three list groups may be subclass as [‘Left’, ‘Right’], [‘Down’, ‘Up’], [‘Right-Up’, ‘Left-Up’, ‘Right-Down’, Left-Down]. A class (Up, Down) may be initially sorted with x1 and then with y1 and may be paired using rule-1 having an opposite direction, coordinates, presence of tail, and number of extension lines. Further, a class (Right, Left)—in a horizontal direction may initially sort with y1 and then with x1 and may then be paired using rule-1 opposite direction, coordinate, presence of tail, and number of extension lines. Further, a class angular arrows (i.e., oblique) may be paired using rule-1 in opposite direction, and a slope calculation may be compared to tail line connecting these arrows (if any).

Referring now to FIG. 16, is an exemplary diagram illustrating classification of a plurality of arrowheads in eight directions is represented, in accordance with an embodiment of the present disclosure. As depicted via the FIG. 16, each of the plurality of arrowheads may be classified in eight directions, such as up, down, right, left, right up, right down, left up, and left down using CNN-II (i.e., the multilayered neural network).

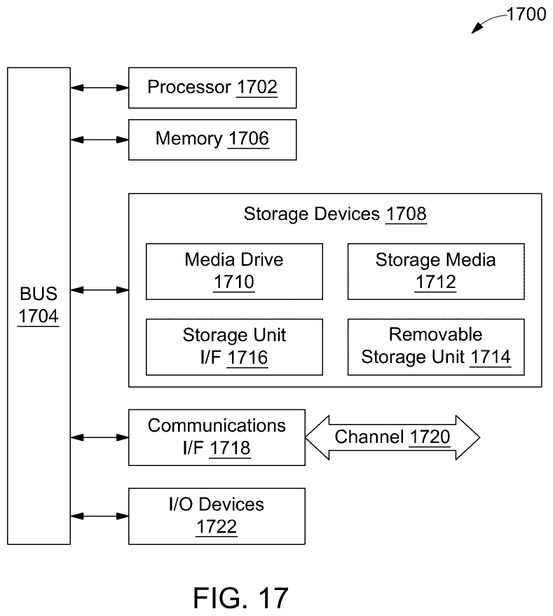

The disclosed methods and systems may be implemented on a conventional or a general-purpose computer system, such as a personal computer (PC) or server computer. Referring now to FIG. 17, an exemplary computing system 1700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 1700 may represent, for example, a user device such as a desktop, a laptop, a mobile phone, personal entertainment device, DVR, and so on, or any other type of special or general-purpose computing device as may be desirable or appropriate for a given application or environment. The computing system 1700 may include one or more processors, such as a processor 1702 that may be implemented using a general or special purpose processing engine such as, for example, a microprocessor, microcontroller or other control logic. In this example, the processor 1702 is connected to a bus 1704 or other communication medium. In some embodiments, the processor 1702 may be an Artificial Intelligence (AI) processor, which may be implemented as a Tensor Processing Unit (TPU), or a graphical processor unit, or a custom programmable solution Field-Programmable Gate Array (FPGA).

The computing system 1700 may also include a memory 1706 (main memory), for example, Random Access Memory (RAM) or other dynamic memory, for storing information and instructions to be executed by the processor 1702. The memory 1706 also may be used for storing temporary variables or other intermediate information during execution of instructions to be executed by the processor 1702. The computing system 1700 may likewise include a read only memory (“ROM”) or other static storage device coupled to bus 1704 for storing static information and instructions for the processor 1702.

The computing system 1700 may also include storage devices 1708, which may include, for example, a media drive 1710 and a removable storage interface. The media drive 1710 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1712 may include, for example, a hard disk, magnetic tape, flash drive, or other fixed or removable medium that is read by and written to by the media drive 1710. As these examples illustrate, the storage media 1712 may include a computer-readable storage medium having stored therein particular computer software or data.

In alternative embodiments, the storage devices 1708 may include other similar instrumentalities for allowing computer programs or other instructions or data to be loaded into the computing system 1700. Such instrumentalities may include, for example, a removable storage unit 1714 and a storage unit interface 1716, such as a program cartridge and cartridge interface, a removable memory (for example, a flash memory or other removable memory module) and memory slot, and other removable storage units and interfaces that allow software and data to be transferred from the removable storage unit 1714 to the computing system 1700.

The computing system 1700 may also include a communications interface 1718. The communications interface 1718 may be used to allow software and data to be transferred between the computing system 1700 and external devices. Examples of the communications interface 1718 may include a network interface (such as an Ethernet or other NIC card), a communications port (such as for example, a USB port, a micro-USB port), Near field Communication (NFC), etc. Software and data transferred via the communications interface 1718 are in the form of signals which may be electronic, electromagnetic, optical, or other signals capable of being received by the communications interface 1718. These signals are provided to the communications interface 1718 via a channel 1720. The channel 1720 may carry signals and may be implemented using a wireless medium, wire or cable, fiber optics, or other communications medium. Some examples of the channel 1720 may include a phone line, a cellular phone link, an RF link, a Bluetooth link, a network interface, a local or wide area network, and other communications channels.

The computing system 1700 may further include Input/Output (I/O) devices 1722. Examples may include, but are not limited to a display, keypad, microphone, audio speakers, vibrating motor, LED lights, etc. The I/O devices 1722 may receive input from a user and also display an output of the computation performed by the processor 1702. In this document, the terms “computer program product” and “computer-readable medium” may be used generally to refer to media such as, for example, the memory 1706, the storage devices 1708, the removable storage unit 1714, or signal(s) on the channel 1720. These and other forms of computer-readable media may be involved in providing one or more sequences of one or more instructions to the processor 1702 for execution. Such instructions, generally referred to as “computer program code” (which may be grouped in the form of computer programs or other groupings), when executed, enable the computing system 1700 to perform features or functions of embodiments of the present invention.

In an embodiment where the elements are implemented using software, the software may be stored in a computer-readable medium and loaded into the computing system 1700 using, for example, the removable storage unit 1714, the media drive 1710 or the communications interface 1718. The control logic (in this example, software instructions or computer program code), when executed by the processor 1702, causes the processor 1702 to perform the functions of the invention as described herein.

It is intended that the disclosure and examples be considered as exemplary only, with a true scope and spirit of disclosed embodiments being indicated by the following claims.

What is claimed is:

1. A method of extracting dimension data from a document, the method comprising:
receiving the document comprising at least one two-dimensional figure and a plurality of dimension sets associated with the at least one two-dimensional figure, wherein each of the plurality of dimension sets comprises:
a dimension value;
a set of extension lines associated with the dimension value; and
a set of arrowheads associated with the dimension value;
detecting the at least one two-dimensional figure in the document;
detecting the plurality of dimension sets distinctly from the at least one two-dimensional figure in the document;
upon detecting the plurality of dimension sets, identifying a plurality of arrowheads associated with the plurality of dimension sets;
clustering the plurality of arrowheads to obtain a plurality of set of arrowheads;
mapping each of the plurality of set of arrowheads with the dimension value; and
extracting dimension data corresponding to each of the plurality of set of arrowheads, based on the mapping.

2. The method of claim 1, wherein the plurality of arrowheads associated with the plurality of dimension sets are identified using a trained machine learning model, wherein the machine learning model is trained using a training image dataset, wherein the training image dataset comprises:
a set of images of unique true arrowheads; and
a set of images of false arrowheads.

3. The method of claim 1, wherein identifying the plurality of arrowheads comprises segmenting each of the plurality of arrowheads from the at least one two-dimensional figure via an image processing algorithm.

4. The method of claim 1, wherein mapping each of the set of arrowheads with the dimension value comprises:
capturing position data associated with the at least one two-dimensional figure and each of the plurality of dimension sets; and
mapping each of the plurality of set of arrowheads with the dimension value based on the position data associated with the at least one two-dimensional figure and each of the plurality of dimension sets.

5. The method of claim 1, further comprising:
converting the at least one two-dimensional figure into a binary image.

6. The method of claim 1, further comprising:
upon identifying the plurality of arrowheads, annotating each of the plurality of identified arrowheads with annotation data, wherein the annotation data comprises:
an orientation of each of the plurality of arrowheads; and
a location of each of the plurality of arrowheads.

7. The method of claim 1, wherein clustering the plurality of arrowheads comprising:
classifying each of the plurality of arrowheads into one of a plurality of orientation-based classifications based on the annotation data and a predefined rule, wherein the plurality of orientation-based classifications comprises:
an upwards orientation;
a downward orientation;
a left orientation;
a right orientation;
a left-upwards orientation;
a left-downward orientation;
a right-upwards orientation; and
a right-downward orientation.

8. A system for extracting dimension data from a document, the system comprising:
a processor; and
a memory communicatively coupled to the processor, wherein the memory stores processor instructions, which, on execution, causes the processor to:
receive the document comprising at least one two-dimensional figure and a plurality of dimension sets associated with the at least one two-dimensional figure, wherein each of the plurality of dimension sets comprises:
a dimension value;
a set of extension lines associated with the dimension value; and
a set of arrowheads associated with the dimension value;
detect the at least one two-dimensional figure in the document;
detect the plurality of dimension sets distinctly from the at least one two-dimensional figure in the document;
upon detecting the plurality of dimension sets, identify a plurality of arrowheads associated with the plurality of dimension sets;
cluster the plurality of arrowheads to obtain a plurality of set of arrowheads;
map each of the plurality of set of arrowheads with the dimension value; and
extract dimension data corresponding to each of the plurality of set of arrowheads, based on the mapping.

9. The system of claim 8, wherein the plurality of arrowheads associated with the plurality of dimension sets are identified using a trained machine learning model, wherein the machine learning model is trained using a training image dataset, wherein the training image dataset comprises:
a set of images of unique true arrowheads; and
a set of images of false arrowheads.

10. The system of claim 8, wherein, to identify the plurality of arrowheads, the processor-executable instructions further cause the processor to segment each of the plurality of arrowheads from the at least one two-dimensional figure via an image processing algorithm.

11. The system of claim 8, wherein, to map each of the set of arrowheads with the dimension value, the processor executable instructions further cause the processor to:
capture position data associated with the at least one two-dimensional figure and each of the plurality of dimension sets; and
map each of the sets of arrowheads with the dimension value based on the position data associated with the at least one two-dimensional figure and each of the plurality of dimension sets.

12. The system of claim 8, wherein the processor executable instructions further cause the processor to:
convert the at least one two-dimensional figure into a binary image.

13. The system of claim 8, wherein the processor executable instructions further cause the processor to:
upon identifying the plurality of arrowheads, annotate each of the plurality of arrowheads with annotation data, wherein the annotation data comprises:
an orientation of each of the plurality of arrowhead; and
a location of each of the plurality of arrowheads.

14. The system of claim 8, wherein, to cluster the plurality of arrowheads, the processor-executable instructions further cause the processor to:
classify each of the plurality of arrowheads into an orientation-based classification of a plurality of orientation-based classifications based on the annotation data and a pre-defined rule, wherein the plurality of orientation-based classifications comprises:
an upwards orientation;
a downward orientation;
a left orientation;
a right orientation;
a left-upwards orientation;
a left-downward orientation;
a right-upwards orientation; and
a right-downward orientation.

15. A non-transitory computer-readable medium storing computer-executable instructions for extracting dimension data from a document, the computer-executable instructions configured for:
receiving the document comprising at least one two-dimensional figure and a plurality of dimension sets associated with the at least one two-dimensional figure, wherein each of the plurality of dimension sets comprises:
a dimension value;
a set of extension lines associated with the dimension value; and
a set of arrowheads associated with the dimension value;
detecting the at least one two-dimensional figure in the document;
detecting the plurality of dimension sets distinctly from the at least one two-dimensional figure in the document;
upon detecting the plurality of dimension sets, identifying a plurality of arrowheads associated with the plurality of dimension sets;
clustering the plurality of arrowheads to obtain a plurality of set of arrowheads;
mapping each of the plurality of set of arrowheads with the dimension value; and
extracting dimension data corresponding to each of the plurality of set of arrowheads, based on the mapping.

16. The non-transitory computer-readable medium of claim 15, wherein the plurality of arrowheads associated with the plurality of dimension sets are identified using a trained machine learning model, wherein the machine learning model is trained using a training image dataset, wherein the training image dataset comprises:
a set of images of unique true arrowheads; and
a set of images of false arrowheads.

17. The non-transitory computer-readable medium of claim 15, wherein identifying the plurality of arrowheads comprises segmenting each of the plurality of arrowheads from the at least one two-dimensional figure via an image processing algorithm.

18. The non-transitory computer-readable medium of claim 15, wherein to map each of the set of arrowheads with the dimension value, the computer-executable instructions are configured for:
capturing position data associated with the at least one two-dimensional figure and each of the plurality of dimension sets; and
mapping each of the plurality of set of arrowheads with the dimension value based on the position data associated with the at least one two-dimensional figure and each of the plurality of dimension sets.

19. The non-transitory computer-readable medium of claim 15, wherein the computer-executable instructions are configured for:
converting the at least one two-dimensional figure into a binary image.

20. The non-transitory computer-readable medium of claim 15, wherein the computer-executable instructions are configured for:
upon identifying the plurality of arrowheads, annotating each of the plurality of identified arrowheads with annotation data, wherein the annotation data comprises:
an orientation of each of the plurality of arrowheads; and
a location of each of the plurality of arrowheads.
